(19) United States
(12) Patent Application Publication
(10) Pub. No.: US 2021/0095974 A1
(43) Pub. Date: Apr. 1, 2021

(54) ROUTE CREATOR

(71) Applicant: ASICS DIGITAL, INC., Boston, MA (US)

(72) Inventors: Joseph P. Bondi, Boston, MA (US); Jonathan Stucklen, Boston, MA (US); Christopher Drouin, Boston, MA (US)

(73) Assignee: ASICS DIGITAL, INC., Boston, MA (US)

(21) Appl. No.: 16/588,733

(22) Filed: Sep. 30, 2019

(51) Int. Cl. G01C 21/34; G01C 21/36

(52) U.S. Cl. CPC G01C 21/3407; G01C 21/3629; G01C 21/3691

(57) ABSTRACT

A route creator that uses weighted geospatial and temporal segments to develop runnability models that, from weight variations of adjacent segments and runnability data that may be temporally adjusted to identify optimal routes through the connection of the geospatial and temporal segments.

### FIELD OF THE INVENTION

The present invention relates to a route creator that uses weighted geospatial and temporal segments to develop runnability models that from weight variations of adjacent segments and runnability data that may be temporally adjusted identifies optimal routes for users through the connection of the geospatial and temporal segments.

### BACKGROUND OF THE INVENTION

For running and cycling enthusiasts, the opportunity to vary their daily route can be difficult, particularly in areas that are not familiar. While several applications provide information based on known routes and their popularity, the development of new routes that are of a desired distance and that provide an ability to traverse across new territory is not known. Most current route indicator applications targeted at athletics, rely on and recommend already established routes that have been ranked in popularity or activity level by users of these already known routes. These routes are set at specific distances and user preference and rankings are based on the entire distant without the segmentation of the route to better define the structural features and athletic skill levels required in traversing the full route. Other applications use only GPS coordinates so that by entering a start point and an end point, the map-based software application connects the two points and recommends the route having the shortest distance or shortest time between the two points. These applications fail to account for user preferences, athletic skill level and the environmental conditions that will make a route more challenging or more pleasurable for the user. The current applications further fail to provide for the creation of loops or overlapping along the route such as by repeating the ascent and descent of a hill or scenic trail along a river to for example increase the activity level and/or overall enjoyment of the user running the route. Whether a traveler in a new city or a user that wants to explore areas outside of their local neighborhood, determining an optimal route that is scenic, safe, and traversable during different times of the day, can be a challenge. Therefore, an improved system and method to address these challenges is desired.

### SUMMARY OF THE INVENTION

The route creator of the present invention which may be referred to herein as Runkeeper™ uses weighted geospatial and temporal segments and runnability modeling to provide for the creation of new routes, the restriction of known routes to desired distances, the option for loops or overlapping to optimize the enjoyment and performance of the user, and routes that are safe and traversable based on the occurrence of activities that take place at certain times of day. The Runkeeper™ application accesses a global coordinate database that includes latitude and longitude information from an extensive number of regions throughout the world. The latitude and longitude information are quantized into geospatial segments that each cover an estimated area of approximately 10 meters×10 meters square. The small dimensions of each discreet segment provide the fine granular analysis necessary in more urban and populated areas. However, the geospatial segment size is configurable to increase segment size in more rural areas having less structural and geographic features. In addition to location and geographic data, each geospatial segment has one or more types of runnability data that may include temporal components that may be correlated to a temporal indicator that shows the time when the user will perform the activity on a created route. A temporal factor may adjust the value of the runnability data based on this correlation to restrict the analysis to runnability data that is related to a particular point in time, day of the week and/or time of the year.

The structural and geographic features are associated with each of the geospatial and temporal segments as runnability data. This runnability data may include geographic features such as lakes, rivers, oceans, forests, elevation data and gradient changes or structural features such as buildings, highways, roads and trails that traverse the geospatial and temporal segment and the size and dimensions of each feature within each geospatial and temporal segment. Geographic information on the type of building and its purpose may also be included and may have temporal components that indicate changes in runnability data. For example, a building that is a retail store, factory, school, or place of worship may have increased activity at particular times of day or particular times during the week. The temporal components may provide the activity level for a certain location at particular times of day and particular times of the week. A seasonal location may have limited activity, inclement weather or be inaccessible at certain times of the year. The temporal components may be included with the geographic runnability data such as data including changes in activity, temperature changes and weather patterns. The value of a certain type of runnability data may be for example adjusted to be lower or higher value based on a particular time of day, day of the week or time of the year. This temporal factor adjustment is derived from a correlation of the temporal components of a type of runnability data to a temporal indicator that includes the time point or duration of when the user will perform the activity on the created route. The temporal factor may therefore apply to almost any type of runnability data to, using the Runkeeper™ application, determine the optimal running routes based on the conditions at different times during the day, week or year. Other types of runnability data with a temporal component are the direction of travel, the average speed of travel, and the popularity of travel through a geospatial and temporal segment and the popularity of traversing from one geospatial and temporal segment to an adjacent geospatial and temporal segment. Runnability data may also be based on user preferences collected in the Runkeeper™ application or from data collected in third-party route and runnability applications. This runnability data from users or third-party applications that may have a temporal component may include variations in traffic and lighting during specific times of day, varying popularity level, the weather conditions and/or forecasts of inclement weather, the noise along any routes, the type of pavement surface, the room between runners or cyclists, the difficulty in traversing the terrain or in the number of gradient rises in elevation. Other criteria such as the quality of the GPS signal within the segment may be collected from user preference comments and/or third-party applications and be associated with specific geospatial and temporal segments.

A rating system is applied to the runnability data of each geospatial and temporal segment and based on the temporal factor, weighted averages and normalization of each type of runnability data, a runnability segment value is determined for each segment. The runnability segment value is determined in some embodiments from the overall statistics of the runnability data of all geospatial and temporal segments and is displayed within a runnability map. In some embodiments, each type of runnability data is weighted and those segments having higher ratings for more highly weighted types of runnability data are given higher runnability segment values than other geospatial and temporal segments having lower ratings within each type of runnability data. Additionally, the rating of the runnability data may be determined based on user selections and preferences. For example, if a user prefers to have a more traveled route, with more level terrain, that is crossed at a higher speed then the geospatial and temporal segments with higher popularity rating, lower elevation, and higher average speed may be given higher runnability segment values based on this user's preferences. The value of a particular type of runnability data may further be adjusted using the temporal factor to restrict the runnability data analysis to runnability data that has temporal components that correlate to the temporal indicator entered or selected by the user to determine the runnability value based on a similar time, date, or day of the week. For other users, interested in more remote and more athletic workouts, geospatial and temporal segments with lower popularity ratings and higher elevation may be given higher runnability segment values based on this user's preferences and the temporal factor. The rating of each type of runnability data may use percentile-based scaling to integrate a user's preference with other types of information such as geographic overlay information to perform a weighted average and to identify outliers. Outliers may indicate non-accessible segments such as inside a building, on water, off the edge of a cliff, or misinformation gathered in areas with none or limited GPS. The percentile-based scaling would provide thresholds and ranges within the rankings to for example prevent a recommendation of the lowest value of popularity which may indicate an unsafe or non-traversable segment, or the highest value of gradient which may be insurmountable without proper equipment. Instead as an example segments having rankings within a 10^{th} to 30^{th} percentile would be recommended to a user desiring a less popular route. The user simply selects or enters their preferences and the runnability segment values for each segment are calculated and displayed based on these preferences. To assist visually, the runnability map may be color coded with similarly weighted segments having similar colors to easily provide general route information to the user based on their preferences.

The size and boundaries of the runnability map, meaning the total number of geospatial and temporal segments within the runnability map, is determined by the user selecting or entering a start point, a distance, and a type of path, such as out and back, add in a loop, back-track and/or overlap within the geospatial and temporal segments. The user may also select to determine their route at the current time or select the time of day that they will be running to plan their route. A different time of day may mean different rankings within each geospatial and temporal segment as traffic, lighting, weather and other factors may change through the day. The date of a planned route may also be entered to be used to evaluate the runnability data within each geospatial and temporal segment. An end point may also be entered if desired. In a first embodiment, the runnability map is created by placing the adjacent geospatial and temporal segments and their runnability segment values that surround the start point and all other geospatial and temporal segments that extend the desired distance from the start point. The route in this embodiment through the adjacent geospatial and temporal segments may therefore be created in any one of eight directions from the start point and return, loop or overlap to reach the desired distance from and/or back to the start point. In another embodiment, the runnability map is created by placing the adjacent geospatial and temporal segments and their runnability segment values that surround the start point and only geospatial and temporal segments that extend the desired distance from the start point towards the end point. The Runkeeper™ application in this embodiment may restrict the route to adjacent geospatial and temporal segments that are in or close to, with a small diversion from the direction of the start point towards the end point. The created route in this embodiment may also, if selected, comprise a path that has a return, loop or overlap to reach the desired distance from the start point to the end point.

In creating the runnability map, the start point is positioned in the center of the base geospatial and temporal segment and vertices extend from the start point in parallel to and perpendicularly to the four sides that form the segment. Vertices also extend at 45-degree angles from the start point splitting the parallel and perpendicular vertices. The vertices extending from the base segment therefore have eight directions that lead to and connect with the eight adjacent geospatial and temporal segments surrounding the base geospatial and temporal segment. Using the Runkeeper™ application, runnability modeling on all of the segments within the runnability map is performed to determine a preferred direction of travel based on the runnability segment values, geophysical and structural features that restrict or prevent travel within certain segments, and the temporal factors for each type of runnability data based on the day, date and time of year. In the runnability modeling, an edge value is determined at each point where a segment meets each adjacent segment, so each segment has eight edge values in addition to the runnability segment value of the segment. Each edge value may be determined based on a comparison of the runnability segment value of one segment and the runnability segment value of the adjacent segment or a comparison of any one type of runnability data of one segment and the same type of runnability data from an adjacent segment, the edge values therefore adjust based on geophysical and structural features as well as user preferences to provide a key variable for the determination of an optimal route for the user through the adjacent segments.

Alternatively, a combination of different types of runnability data of one segment may be compared to an adjacent segment to determine an edge value with the types of runnability segment values used in the determination being based on the user preferences selected. As noted previously, for a user that selected popularity as an important preference with limited elevation, then the adjacent segments with higher popularity and lower elevation change will be given higher edge values to assist in determining an optimal direction. However, if an edge value of one of the eight adjacent segments is well below the runnability segment value selected or outside of a determined proportional threshold, this edge value may be zero or negligible to have the adjacent segment be negated from further analysis within the runnability model. Edge values may further be degraded for a low number of transitions between two segments relative to the popularity ratings of one segment and the other adjacent segments. Additionally, edge values may be ranked lower if adjacent geospatial and temporal segments have non-traversable geographic features such as a highway or river suggesting restricted or limited transitions to these adjacent geospatial and temporal segments. However, the geospatial and temporal segments having the lower edge values along the non-traversable segments may have high runnability segment values, such as a scenic route along a waterway. The temporal components for each type of runnability data may also be used in determining an edge value. For example, the temporal factor may decrease the edge value for an adjacent segment that is non-traversable in the middle of winter due to snow and ice and may increase the edge value for the same adjacent segment that is accessible and easily traversable in the summer. The temporal factor therefore adjusts the overall runnability data ranking and the edge values of each geospatial and temporal segments based on the time of day, day of the week, and/or time of year. Additionally, adjacent segments in a similar direction that have lower ratings of certain preferential types of runnability data than adjacent segments being used for comparison, forces the selection of a subsequent adjacent segment in a different direction based on the runnability segment values. In the event, the adjacent segments do not meet a range of acceptable values, the Runkeeper™ application provides for the created route to return, backtrack or overlap by cutting across a segment previously designated within the route in order to select the optimal adjacent segment when edge values of the next subsequent adjacent segments are outside of predetermined thresholds for runnability segment values.

The Runkeeper™ application is therefore very different from current route indicator applications that simply direct users to popular known routes within an area that is close to the user without an analysis of the quality of each geospatial and temporal segment based on that segment's runnability data for all geospatial and temporal segments within that known route. Additionally, unlike applications that allow the user to enter a start point and an end point and be directed using GPS coordinates to one or more routes that connect the two points as in some map-based software applications, the Runkeeper™ application performs an analysis of the quality of runnability data within each geospatial and temporal segment that would connect the start point and end point and makes route recommendations based on this analysis.

Also presented within the runnability map is the user selected or entered start point, the desired distance from the start point, and/or an end point. If an end point is not entered, then the desired distance from the initial base geospatial and temporal segment having the start point is calculated using, for example, the Haversine formula (which determines the distance between two points along a sphere based on their longitudes and latitudes). A runnability map is created that includes all geospatial and temporal segments from the start point to the desired distance. The runnability map is therefore formed as squares of roughly 10 meters×10 meters of geospatial and temporal segments from and around the geospatial and temporal segment with the start point to the desired distance if an end point has not been entered or from the geospatial and temporal segment with the start point with geospatial and temporal segments that are towards the geospatial and temporal segment with the end point if a desired end point has been entered. If an end point has not been entered, then end points are identified within all geospatial and temporal segments that are at the desired distance from the start point and the shortest path to each of these end points is determined using an algorithm such as Dijkstra's algorithm.

Using Dijkstra's algorithm an analysis to determine the shortest distance to an end point is made from the start point and if the distance to an adjacent segment is less than the distance to an identified end point, then the distance to the adjacent segment is kept as the tentative distance. The adjacent segment is marked as visited, and a comparison of the next adjacent segment to the distance to the identified end point is made. If the next adjacent segment has a shorter distance to the identified end point than the previously visited segment, this shorter distance is set as the tentative distance. The distance of all of the segments that are adjacent to the initial base segment are made and the adjacent segment with the shortest distance to the selected end point is marked as a new base segment. The initial base segment and other adjacent segments are marked as visited. The distance to the identified end point from all of the segments that are adjacent to the new base segment are made and the adjacent segment with the shortest distance to the identified end point is marked as a next new base segment. The prior new base segment and the other segments adjacent to the prior new base segment are marked as visited. The determination of the shortest distance to the identified end point from all of the segments that are adjacent to the next new base segment are made and the determination of the distances and identifying a next new base segment is repeated until all unvisited adjacent segments have been compared to the distance to the identified end point and each of the prior next new base segments and all other adjacent segments have been marked as visited.

In the Runkeeper™ application a modification to Dijkstra's algorithm that incorporates the runnability data from each geospatial and temporal segment is made. In the Runkeeper™ application shortest distance analysis in addition to the comparison of the distance from the start point to the endpoint and an adjacent segment to the endpoint to select the next base segment, the runnability segment value of the adjacent geospatial and temporal segment is inverted and multiplied by the distance to adjust the distance based on the runnability segment value. For example, if the runnability data of a first adjacent geospatial and temporal segment is a “4” with a distance of 6 kilometers then the product of the inverted runnability segment value ¼ and the distance of 6 kilometers is the runnability distance value of 1.5=¼×6 is determined. If the runnability segment value of a second adjacent geospatial and temporal segment is a “8” with a longer distance of 6.5 kilometers to the identified end point, then the product of the inverted runnability segment value is ⅛ and the distance of 6.5 kilometers is the runnability distance value of 0.8125=⅛×6.5, so even though the overall distance is longer, because the runnability segment value is smaller when inverted the second geospatial and temporal segment has a shorter runnability distance value and will be selected as the better traversable geospatial and temporal segment.

As noted above the runnability segment value may be a weighted average of different types of runnability data or be specific to a single type of runnability data such as popularity, so if the user selects a preference of a more popular route, the inversion of a runnability type value that is determined from the popularity runnability data collected for the geospatial and temporal segment is performed. The runnability type value for popularity is then combined with distance in order to decrease the distance of the more popular geospatial and temporal segments and determine shorter distances to these geospatial and temporal segments. These geospatial and temporal segments are therefore selected preferentially over other geospatial and temporal segments having lower runnability type values for popularity. The runnability distance value analysis continues until the identified end point segment is selected as the next new base segment or all geospatial and temporal segments are marked as visited. The initial base segment and all of the new base segments identified in the analysis as having lower runnability distance values are connected to form possible preferential routes from the start point to the identified endpoint having the desired distance or to the desired end point if one has been entered. The geospatial and temporal segments of the identified optimal routes are then rated based on the runnability distance values of each geospatial and temporal segment.

From this analysis, the Runkeeper™ application identifies certain geospatial and temporal segments that have runnability segment values below proportional thresholds as negated from the runnability distance value analysis. These geospatial and temporal segments may include non-traversable geographic or structural features such as rivers, lakes, forests, highways, buildings, and restricted non-traversable areas. From the runnability distance value analysis, geospatial and temporal segments that have runnability distance values below proportional thresholds may also be negated from the runnability modeling and marked as non-traversable to remove them from further analysis in creating routes. In determining the optimal route from the remaining traversable geospatial and temporal segments, user preferences, the direction of travel, the average speed of travel, the popularity of the segment, the popularity of traversing from one segment to an adjacent segment, variations in traffic and lighting during specific times of day, the quality of the GPS signal within each segment, and other types of runnability data that may be collected are used to rate each geospatial and temporal segment and weigh one of the identified routes of the desired distance over another. Each of these types of runnability data may have a temporal component to be used to determine overall runnability segment value for each geospatial and temporal segment. The analysis, evaluation and marking of each geospatial and temporal segment within a created route also provides for completely new routes to be created by excluding some or all geospatial and temporal segments within a route that has been previously selected by the user, thereby creating a completely different route from those the user has run previously. Additionally, pattern analysis of the created routes can be performed to evaluate the amount of curvature or changes in direction within a route and reduce or smooth out these curvatures to improve the runnability of the created route. The use of geospatial and temporal segments further provides for loops and overlapping within a route by using the runnability data and desired distance to determine points along the route that can be traversed again. If in some created routes there are not suitable geospatial and temporal segments to create a loop, the Runkeeper™ application will prompt the user to choose a different created route where a loop is suitable or choose to change the type of path. For example, by choosing an out and back path, the desired distance is divided in half and a halfway point at this distance is determined and the user then reverses direction and returns to the start point along the same created route thereby overlapping the geospatial and temporal segments within the created route.

Every created route is saved with the runnability data for each geospatial and temporal segment and user preferences and this information is used by the Runkeeper™ application to improve the selection of geospatial and temporal segments based on the routes selected by the user, any feedback provided by the user and others within the runnability data, and user preferences. From this information, the Runkeeper™ application can develop and allow users to select an option for a completely new route that may not have been created before providing both variability and new attractions for the user experience. The Runkeeper™ application therefore performs a continual analysis of user preferences, their selected routes, and the different types of runnability data with their temporal components in order to tailor routes, using machine learning, that meets the user's preferences, particularly when a user requests a route to be created in a new location. By continual optimization from both user feedback and external sources providing geophysical information and runnability data about each geospatial and temporal segment, the Runkeeper™ application improves the quality of the routes created and thereby the enjoyment of the user in their athletic activities.

These and other features, advantages and improvements according to this invention will be better understood by reference to the following detailed description and accompanying drawings. While references may be made to upper, lower, vertical and horizontal, these terms are used merely to describe the relationship of components and not to limit the installation or use of the present invention to any one orientation.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 illustrates a network system configured for the collection, analysis, and communication of geographic, geophysical and runnability data in an embodiment of the present invention;

FIG. 2 illustrates geospatial and temporal segments and a created route from the latitude and longitude of areas throughout the world in an embodiment of the present invention;

FIG. 3A illustrates an area to be used to create a route in an embodiment of the present invention;

FIG. 3B illustrates the quantization of the latitude and longitude of the area of FIG. 3A into geospatial and temporal segments in an embodiment of the present invention;

FIG. 3C illustrates the marking of geospatial and temporal segments within the area of FIG. 3A as non-traversable and a start point and range of end points within a desired distance in an embodiment of the present invention;

FIG. 3D is a flowchart of the steps in marking of geospatial and temporal segments within the area of FIG. 3A as non-traversable in an embodiment of the present invention;

FIG. 4A illustrates different types of runnability data with ratings within each geospatial and temporal segment to be used to create a route in an embodiment of the present invention;

FIG. 4B illustrates different types of runnability data with ratings and known routes within each geospatial and temporal segment to be used to create a route in an embodiment of the present invention;

FIG. 4C illustrates different types of runnability data with ratings and an overall weighted average for each geospatial and temporal segment to be used to create a route in an embodiment of the present invention;

FIG. 4D illustrates an embodiment of a runnability segment value of each geospatial and temporal segment based on overall weighted averages of the different types of runnability data within each geospatial and temporal segment to be used to create a route in an embodiment of the present invention;

FIG. 4E illustrates an embodiment of a runnability segment value and color coding of each geospatial and temporal segment based on overall weighted averages of the different types of runnability data within each geospatial and temporal segment to be used to create a route in an embodiment of the present invention;

FIG. 4F is a flow chart of determining a runnability segment value for each geospatial and temporal segment from the different types of runnability data within each geospatial and temporal segment based on available data and user preferences in an embodiment of the present invention;

FIG. 5A is an embodiment of the Runkeeper™ application of the present invention;

FIG. 5B is an embodiment of a “Get Started” screen in an embodiment of the Runkeeper™ application of the present invention;

FIG. 6A is an embodiment of popular routes within the city of Boston in an embodiment of the Runkeeper™ application of the present invention;

FIG. 6B is an embodiment of popular routes within the city of Sydney in an embodiment of the Runkeeper™ application of the present invention;

FIG. 6C is an embodiment of popular routes within the city of London an embodiment of the Runkeeper™ application of the present invention;

FIG. 7A is an embodiment of a “User Preference” screen to enter distance in an embodiment of the Runkeeper™ application of the present invention;

FIG. 7B is an embodiment of a “Find Me a Route” screen in an embodiment of the Runkeeper™ application of the present invention;

FIG. 7C is a flowchart of the steps in creating a route within an area in an embodiment of the present invention;

FIG. 7D is an embodiment of a created route in an embodiment of the Runkeeper™ application of the present invention;

FIG. 8A is an embodiment of a user preference screen to select the type of path to be run in an embodiment of the Runkeeper™ application of the present invention;

FIG. 8B is an embodiment of a “Generating Your Custom Route” screen in an embodiment of the Runkeeper™ application of the present invention;

FIG. 9 is an embodiment of a created route having an overlapped portion in an embodiment of the Runkeeper™ application of the present invention;

FIG. 10 is an embodiment of a runnability segment value for each geospatial and temporal segment with edge values with respect to adjacent segments within an embodiment of a runnability map in an embodiment of the Runkeeper™ application of the present invention;

FIG. 11 is an embodiment of a runnability segment value for each geospatial and temporal segment with edge values and created optional routes within an embodiment of a runnability map in an embodiment of the Runkeeper™ application of the present invention;

FIG. 12A is an embodiment of a “Main menu” screen in an embodiment of the Runkeeper™ application of the present invention; and

FIG. 12B is an embodiment of a “Settings” screen in an embodiment of the Runkeeper™ application of the present invention.

### DETAILED DESCRIPTION OF THE INVENTION

The terminology used herein is for the purpose of describing particular embodiments only and is not intended to be limiting of the invention. As used herein, the singular forms “a,” “an,” and “the” are intended to include the plural forms as well as the singular forms, unless the context clearly indicates otherwise. It will be further understood that the terms “comprises” and/or “comprising” when used in this specification, specify the presence of stated features, steps, operations, elements, and/or components, but do not preclude the presence or addition of one or more other features, steps, operations, elements, components, and/or groups thereof. Additionally, the terminology selected or entered are related to the acquisition of data through a software application and may be interchangeable in most instances to facilitate the collection of data.

Unless otherwise defined, all terms (including technical and scientific terms) used herein have the same meaning as commonly understood by one having ordinary skills in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

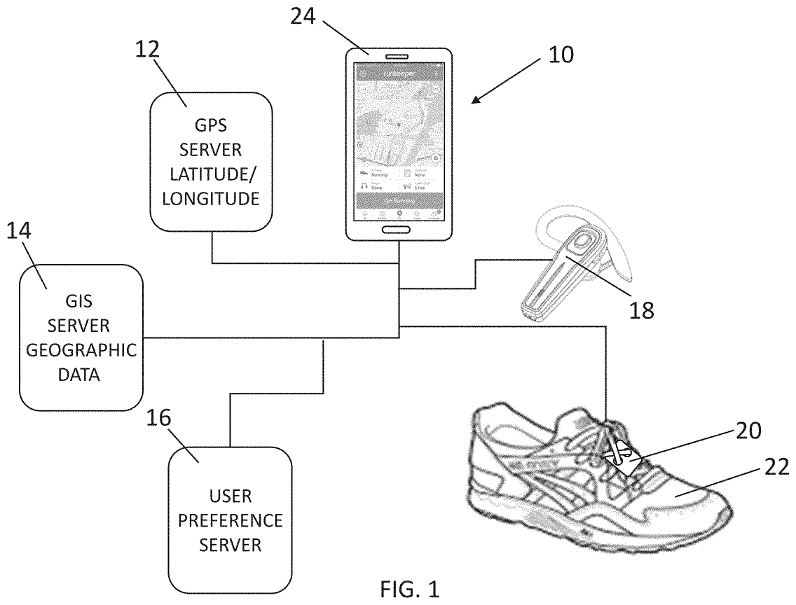

Aspects of the present invention relate to computer programs embodied within computer readable storage mediums and/or processors that execute instructions stored on and/or provided in memory coupled to the processor all of which are operable to implement methods within computer systems that may utilize a plurality of networks. Certain embodiments of the implementation of the present invention may be configured to adapt to dynamic network environments and architectures. Network architectures may include one or more information distribution networks of any type or topology, alone or in combination with others such as for example, cable, fiber, satellite, cellular, and wireless with the implementation of wired or wireless communication channels such as WiFi®, Bluetooth®, Near Field Communication (NFC) and/or ANT technologies providing for communication to any device within one or more logical network systems. The present invention may further comprise a network adaptor or network interface card (NIC) configured to translate data and control signals into and from network messages based on the network architecture using applicable communication protocols such as the Transmission Control Protocol (TCP), the Internet Protocol (IP) and others. As shown in FIG. 1, the Runkeeper™ application 10 is implemented within a dynamic network system to create runnability maps and routes that are optimal for users through an analysis and integration of runnability segment values associated with specific geospatial and temporal segments of in some embodiments approximately 10 meters×10 meters squares. The runnability maps are developed from data accessed from geographical positioning satellite (GPS) Servers 12, geographic information system (GIS) Servers 14 and a User Preference Server 16. The GPS Server 12, provides GPS coordinates as latitude and longitude of the location of the user and of the region the user desires to perform an activity in such as walking, running or cycling through the region. Geographic data from the GIS Server 14 may include, elevation, altitude, topology, transportation routes, location pictures, and geocoding that are used to identify natural geophysical features of the environment such as rivers and lakes, man-made structures such as buildings, roads and bridges, weather, and address information within the region. The User Preference Server 16 provides data that may be compiled from data provided by one or more users to the Runkeeper™ application 10 or derived from within the Runkeeper™ application 10 and/or from one or more third party fitness, tourism, traffic, weather or other applications. Data may further be received and transmitted using the Runkeeper™ application 10 to an audio device such as a Bluetooth® headphone 18 to provide for example directions along a created route to a user or an RFID Tag 20 to capture real time location and distance information and update a route for the user based on changes to conditions along the route. For example, the Runkeeper™ application 10 may identify inclement weather near to the location of a user and suggest an immediate change to a route to direct a user to a different location. The RFID Tag 20 may be worn by the user on their athletic shoes 22 or be attached to an article of clothing of the user. The Runkeeper™ application 10 is operable on a smartphone 24 that the user carries while running or on a tablet, laptop or other computer processing system with a graphical display to indicate to the user optimal routes and ratings for each route created.

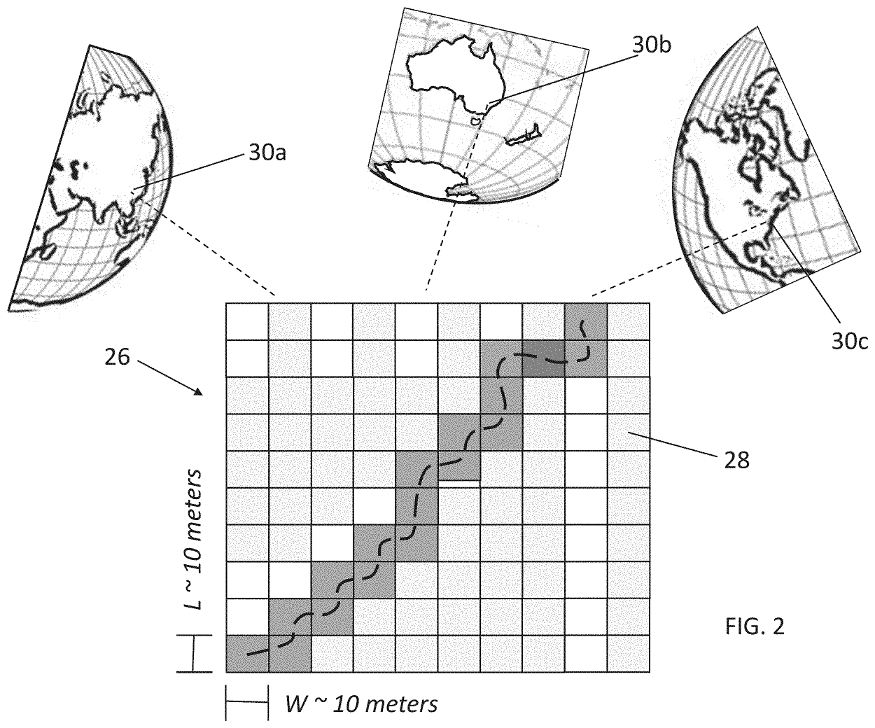

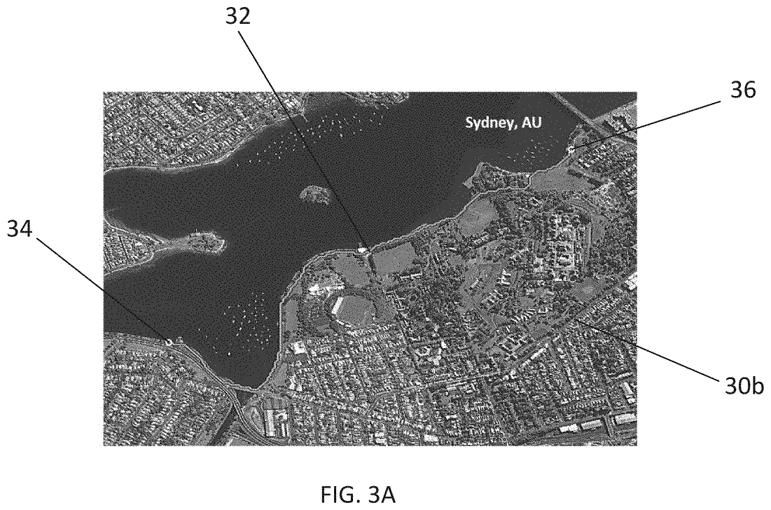

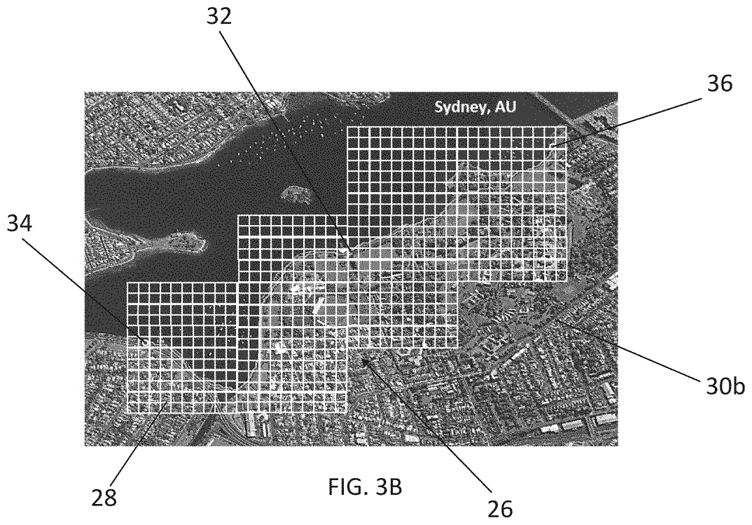

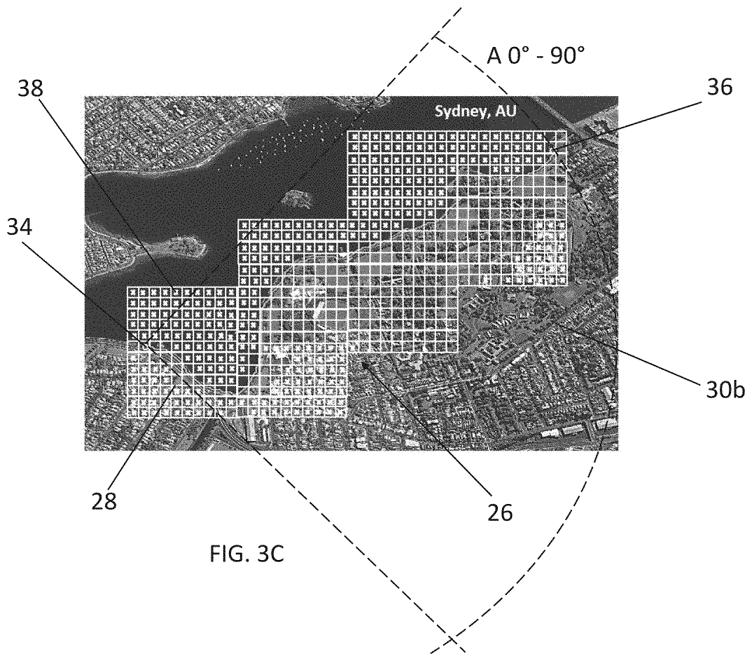

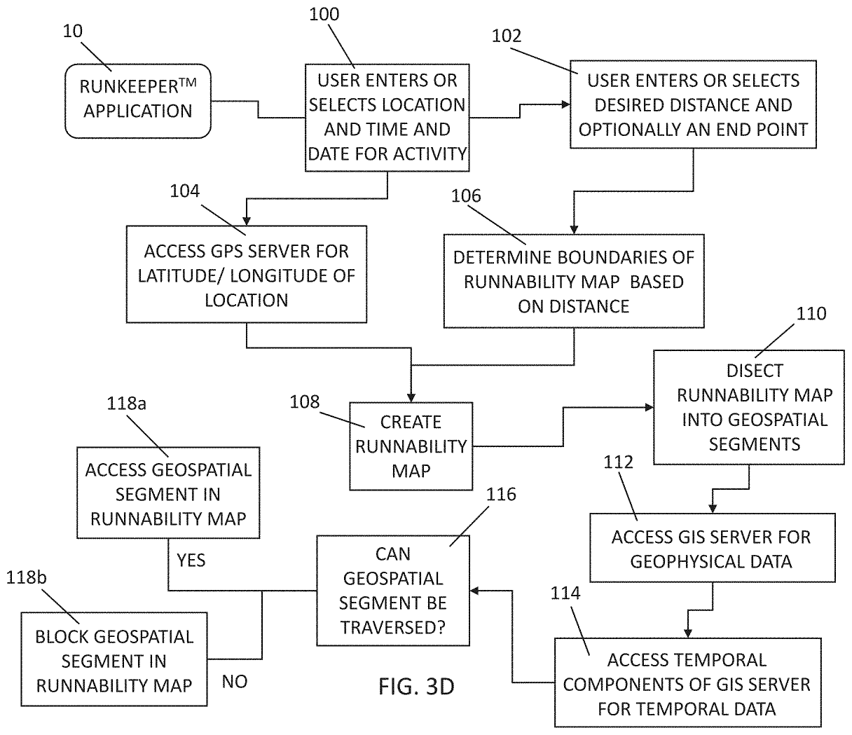

As shown in FIG. 2, from the geographical positioning data from around the world, the latitude and longitude are quantized to develop a runnability map 26 of equal sized geospatial and temporal segments 28. The length 1 and width w of each geospatial and temporal segment 28 may be approximately 10 meters×10 meters or any suitable dimension and may be configurable as required for a specific location such as for a city in China 30a, a city in Australia 30b, or a city in the United States 30c. By having global coverage, the Runkeeper™ application 10 is especially beneficial for a user that is traveling to a new city such as Sydney, Australia 30b where a route 32 can be created in completely unfamiliar territory to the user. The route 32 created can further be optimized to give the user both a scenic and an athletic challenge through areas that the user has never visited before as shown in an example in FIG. 3A. To create a route 32, a user selects or enters an initial location or start point 34, a distance and optionally an end point 36. The user may further select the current time and date or enter the time and date that they plan to run, bike, or perform another activity along the route. This temporal indicator 37 is used to correlate with temporal components 39 of different types of runnability data 40 to the point in time and a calculated duration of the user performing the activity along the created route. The user also enters any preferences such as a desire that the route 32 be scenic, have more difficult terrain to traverse for a more athletic activity, or be a more popular as examples. From the run requirements data and temporal indicator 37, the Runkeeper™ application 10 accesses the quantized latitude and longitude runnability map 26 from the entered location 30. If an end point 36 is entered, the Runkeeper™ application 10 limits the geospatial and temporal segments 28 to those in a direction towards the end point 36, as shown in FIG. 3B. The Runkeeper™ application 10 then limits the number of the geospatial and temporal segments 28 within the runnability map 26 to the number necessary to cover that distance as measured from the start point 34 which may include geospatial and temporal segments 28 at the desired distance D and within an arc A from the start point 34 of between 0° and 90° as shown in FIG. 3C. Additionally, the route creation analysis uses geographic data from the GIS Server 14 to perform a selection of geospatial and temporal segments 28 that have traversable terrain. As shown in an example FIG. 3C, excluded geospatial and temporal segments 38 that cover a waterway, have buildings, highways and other non-traversable geophysical and man-made features are marked with an X to indicate that these geospatial and temporal segments 28 are blocked from being traversed and excluded within the runnability map 26 from use in the route creation analysis.

As shown in FIG. 3D, the steps to create a runnability map 26 are shown with a first step 100 of the user entering or selecting the desired location where the route 32 will be created with the temporal indicator 37 of the time and date when they will run, bike, or perform another activity along the created route 32. At step 102 the desired distance and optionally an end point 36 are entered or selected by the user. The end point 36 may be the start point 34 so that the distance is divided in half and the created route may overlap along the route created to the halfway distance point or one or more loops may be created within the loop to have the created route return to the start point 34. At step 104 the latitude and longitude data for the location is accessed from the GPS server 12. At step 106 the boundaries of the runnability map 26 are determined based on the desired distance and at step 108 the runnability map 26 is created. At step 110, the runnability map 26 is dissected into geospatial and temporal segments 28. At step 112, the structural components of the geophysical data from the GIS Server 14 are accessed and a determination is made as to whether a particular geospatial and temporal segment 28 can be traversed based on the presence of waterways, buildings, highways and/or other non-traversable geophysical and man-made features. At step 114, the temporal components 39 such as weather, lighting, traffic, activity, GPS signal, and other types of runnability data 40 that may change within a geospatial and temporal segment over a period of time are accessed and a determination is made as to whether the geospatial and temporal segment can be traversed based on the temporal components 39 of the runnability data 40. At step 116, the geospatial and temporal segments 28 that are traversable, meaning there are not geophysical structures such as for example a waterway or inclement weather at the point in time of the temporal indicator 37 that would prohibit a user from crossing the geospatial and temporal segment 28, are added and accessible to the runnability map 26 to create one or more routes 32 for the user at step 118a and the geospatial and temporal segments 28 that are not traversable, are blocked at step 118b as un-accessible and are not used in the creating of one or more routes 32 for the user.

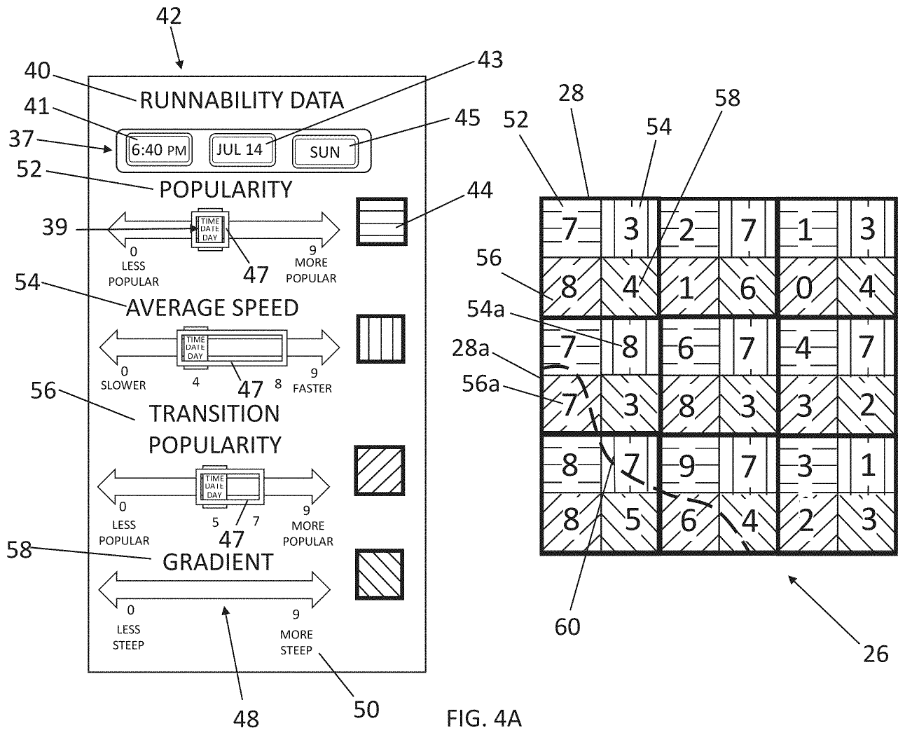

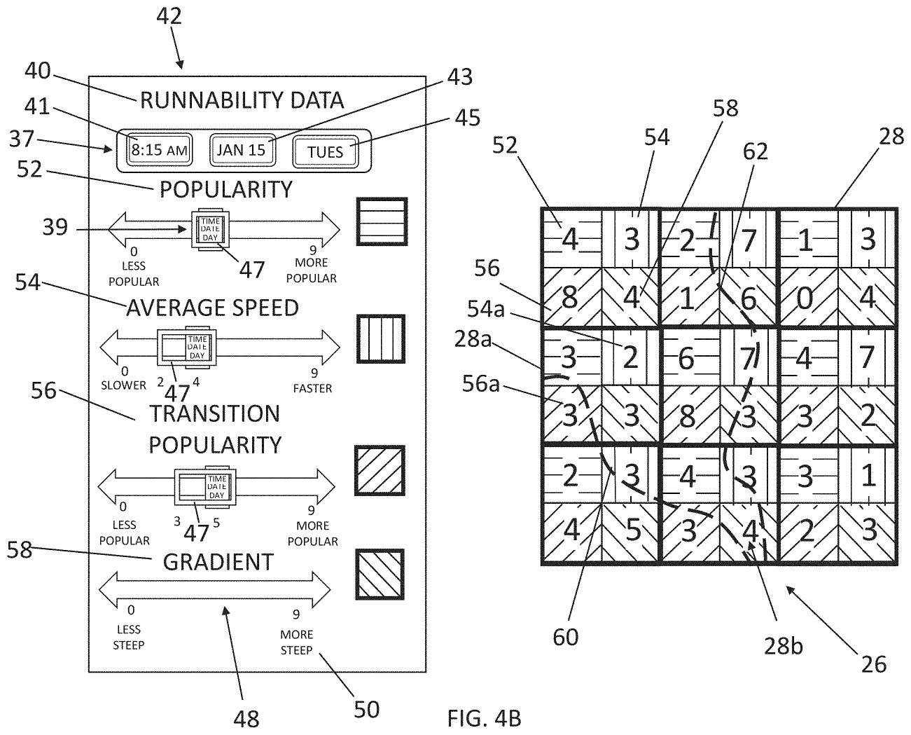

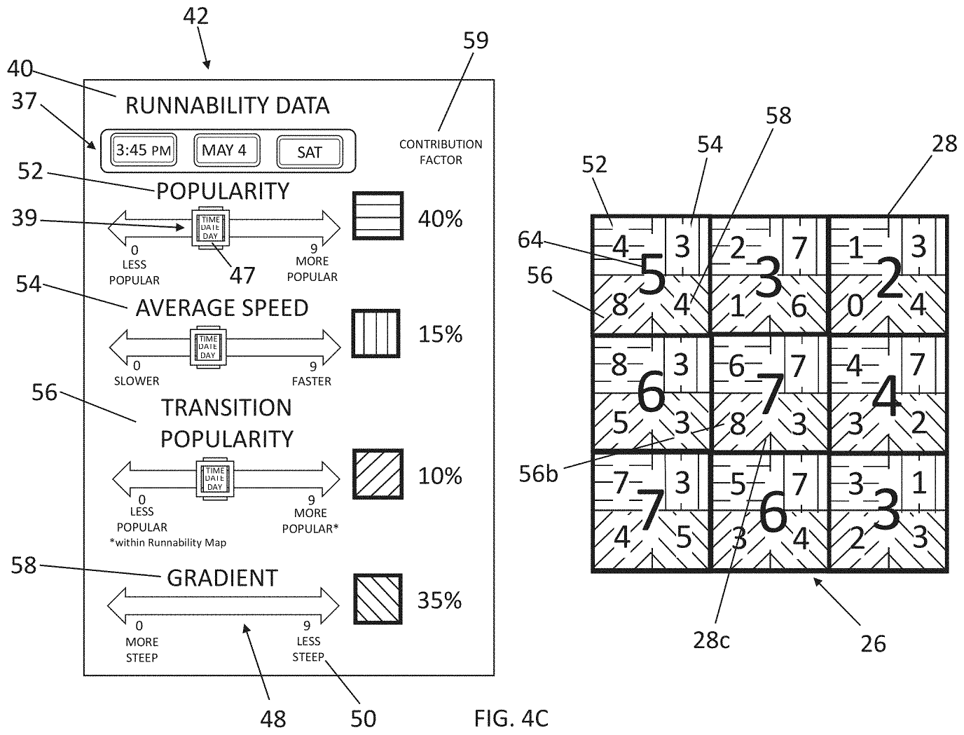

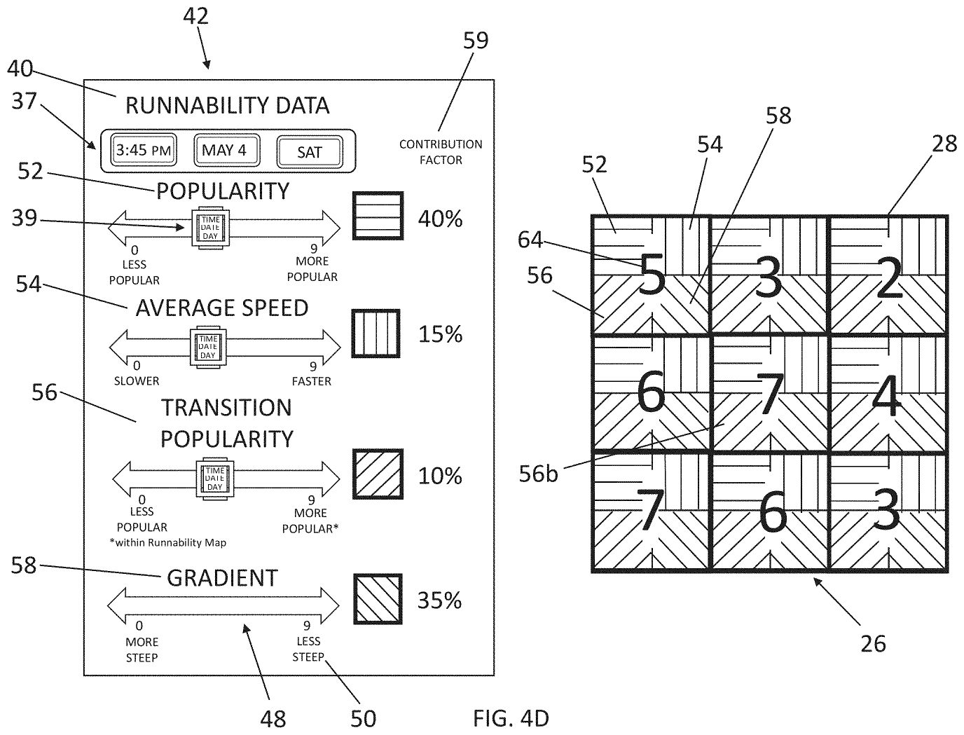

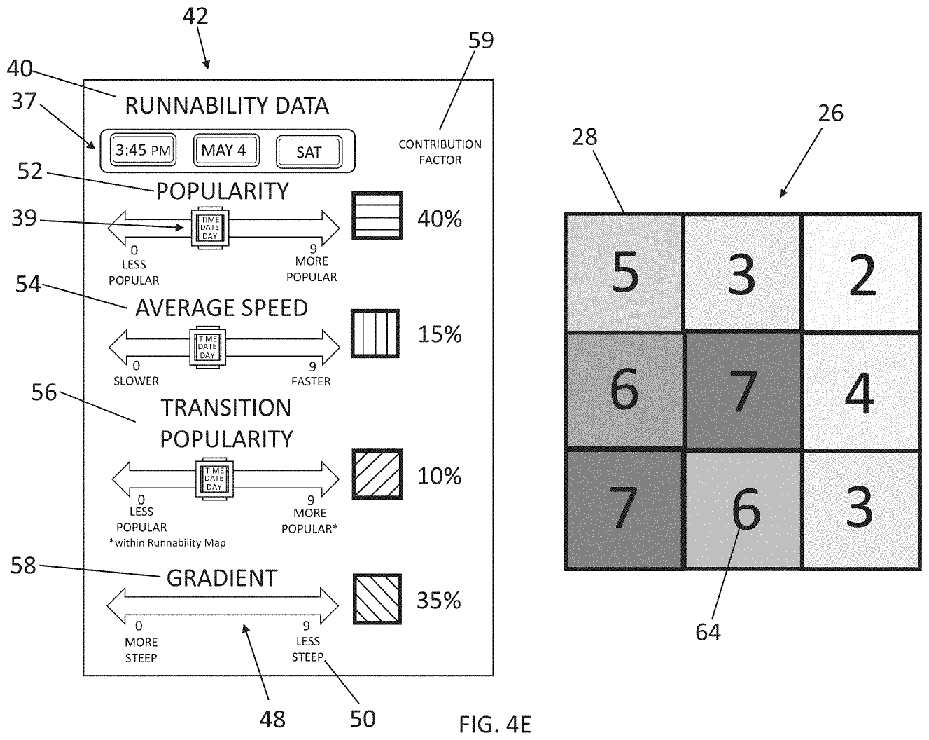

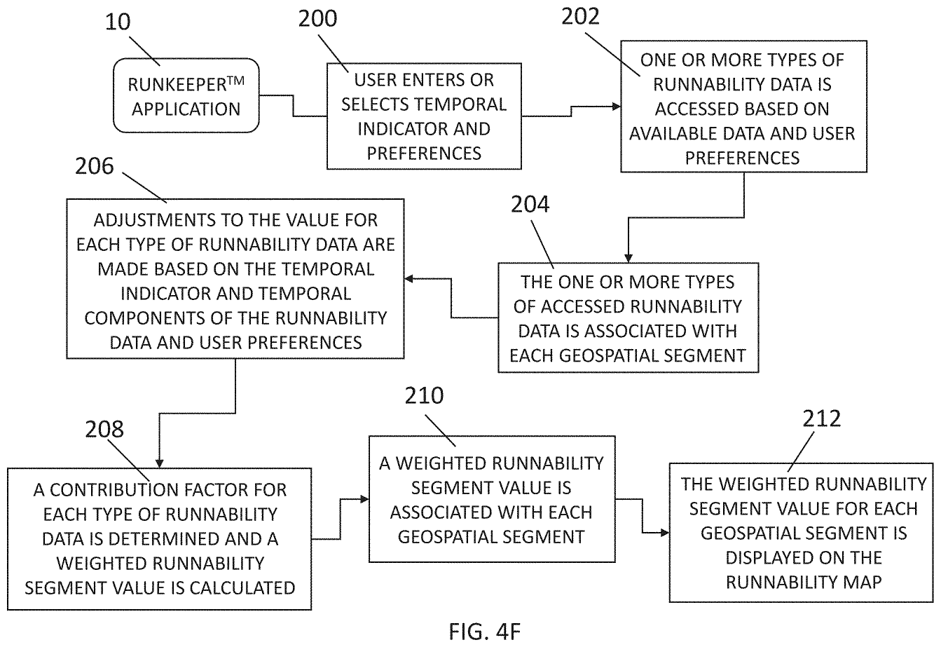

as shown in FIG. 4A, after the runnability map 26 is constructed the Runkeeper™ application 10 optimizes the route 32 based on the selected user preferences and temporal indicator 37 that includes the time 41, date 43 and day 45 of the week. Each type of runnability data 40 that is associated with the entered or selected user preference is accessed for each of the remaining geospatial and temporal segments 28. Each type of runnability data 40 may be associated with one geospatial and temporal segment 28 or with a group of geospatial and temporal segments depending upon the type of runnability data 40. For example, if a value for a particular type of runnability data 40 is associated with a group of geospatial and temporal segments 28 and not just one geospatial and temporal segment 28, all geospatial and temporal segments 28 within the group may be given the same value for that type of runnability data 40. Alternatively, the value may be averaged across the group of geospatial and temporal segments 28 or be compared with similar values from different sources such as a comparison of a particular type of runnability data 40 collected from users of the Runkeeper™ application 10 with runnability data 40 collected from a third-party application to determine the best overall value for each type of runnability data 40 for each geospatial and temporal segment 28. For additional runnability data 40, the Runkeeper™ application 10 facilitates access to the GPS Server 12 and GIS Server 14 to include geophysical features of the environment in the runnability data 40. The Runkeeper™ application 10 may use other database servers, strategies and algorithms to collect runnability data 40 and assign appropriate runnability segment values to each geospatial and temporal segment 28 based on the type of runnability data available. The collected runnability data 40 may include one or more temporal components 39 such as the time, date and day of the week related to the point in time when the runnability data 40 is collected or a time point that the collected runnability data is referring to. By associating a type of runnability data 40 with these temporal components 39, the Runkeeper™ application 10 identifies temporal patterns that may adjust the value for a type of runnability data based on the time of day, day of the week, or time of year. The amount of adjustment may be based on one of or all of the temporal components 39 of time, date and day that the collected type of runnability data 40 refers to in relation to the temporal indicator 37 entered by the user. In some cases, the amount of adjustment, referred to as a temporal factor 47, is based on external data such as an unexpected occurrence or event within one or more geospatial and temporal segments 28. All of the available runnability data 40 of different types from all available sources may therefore be collected and associated with each geospatial and temporal segment 28. In the event that one or more geospatial and temporal segments 28 do not have data for a particular type of runnability data 40, that type of runnability data 40 may be excluded from further analysis or a default or value of zero may be associated with those one or more geospatial and temporal segments 28 for that type of runnability data 40. For example, in rural areas where there may not be as much runnability data collected as in urban areas some types of runnability data may not be available. If there is not enough runnability data to perform an analysis for route creation, the Runkeeper™ application 10 may return a message communicating that none of the created routes meet the criteria of the user.

As shown in FIG. 4A, the different types of runnability data 40 may be indicated within an index 42 having identifying blocks 44 that may show specific line segment patterns, tones of shading or specific colors to indicate within a runnability map 26 one or more types of runnability data 40. The user specified temporal indicator 37 showing the time 41, date 43 and day 45 and the specific runnability data 40 related to the entered user preferences may be provided within the index 42. Also, within the index the runnability value scale 48 indicates the range and increments of value that are associated with a particular type of runnability data 40. Some types of runnability data 40 may have one or more temporal components 39 that include the time, the date, and the day of the week related to the collected runnability data 40. The related temporal components 39 are used in relation to the user preferences to determine the temporal factor 47 to adjust the runnability value for each type of runnability data 40 based on changes throughout a day, a week or a year to more appropriately tailor the created route 32 to the user's preferences at a particular point in time and during the time period that they will be performing the activity along the created route 32. The temporal factor 47 is determined with respect to the runnability value scale 48 to show the amount of adjustment necessary to meet the user preference requirements and optimize the runnability segment values for each geospatial and temporal segment 28. A description 50 of the increments of value of a particular type of runnability may be provided as being less or more, lower or higher, faster or slower, or using any other description appropriate to indicate the comparison of the values along the runnability value scale 48.

One type of runnability data 40 may be a popularity value 52 which indicates the number of times an activity by a user has traversed the geospatial and temporal segment 28. Popularity values 52 may be based on the total number of runners that entered the popularity data into the Runkeeper™ application 10 or entered popularity data into a third-party software application that is accessed by the Runkeeper™ application 10 with the data reflecting that they had traversed a geospatial and temporal segment or traversed a route going through one or more geospatial and temporal segments. The determination of the popularity value 52 may also take into account the total number of comments received from users about one or more geospatial and temporal segments and popularity data that may be collected using a ranking system where the user selects from a scale of, for example, 0-10 with 10 reflecting a higher quality route through the geospatial and temporal segments. Popularity data may also be through access to specific information such as the space between runners or the amount of noise within an area may be collected to create detailed runnability data associated with each of the geospatial and temporal segments along a route.

Other types of runnability data in this example are an average speed of travel value 54 across a geospatial and temporal segment 28 which may be determined by using an RFID Tag 20 worn by one or more users on their athletic shoes 22 or be attached to an article of clothing to track the speed of the user through a geospatial and temporal segment 28. The tracking of one or more users may also be used to determine a transition popularity value 56 indicating the number of times users have traversed from one geospatial and temporal segment 28 to another geospatial and temporal segment 28. From the GIS server 14, a gradient value 58 may be included as a type of runnability data 40 indicating the elevation and changes in elevation across a geospatial and temporal segment 28. Runnability data 40 may also include the lighting at different times of day, traffic patterns for roads, types of pavement surfaces, current weather conditions and other information from one or more third party fitness, tourism, traffic, weather or other applications that collect structural or temporal runnability data on routes that traverse one or more geospatial and temporal segments 28.

In this example, in FIG. 4A, the Runkeeper™ application 10 accesses the User Preference Server 16 for the popularity value 52, the average speed value 54, and transition popularity value 56 and associates these collected or determined values with each geospatial and temporal segment 28. For example, if each type of runnability data 40 is collected for each individual segment then each of those values are associated with that specific geospatial and temporal segment 28. If the value of a type of runnability data 40 is associated with a group of geospatial and temporal segments 28 then a value is determined by averaging, statistical variance, weighting, or by other algorithms and methodologies to either associate the same value in each of the geospatial and temporal segments 28 within the group or associate a specific value for the type of runnability data 40 in each geospatial and temporal segment 28 within the group based on the determination using the one or more algorithms and methodologies. Any of the values of the different types of runnability data 40 may have temporal components 39 that includes the time, date, and day of the week. By using the temporal components 39 information and the temporal indicator 37 entered or selected by the user the Runkeeper™ application 10 determines a temporal factor 47 that adjusts the runnability value for a specific type of runnability data 40 to optimize the runnability segment value during the point in time when the user is performing the activity along the route 32.

One example of the use of the temporal components 39 is shown in the adjustment of the popularity value 52, the average speed 54 and the transition popularity 56 from FIG. 4A to FIG. 4B. In this example as shown in FIG. 4A the runnability data 40 on popularity is collected from a number of users running a known route 60 with the data being collected and referring to running the route 60, the day 45 of the week is Sunday, the date 43 is July 14 and the time 41 is 6:40 pm in the evening. The route 60 goes along a school and in the summer, the average speed values 54 and transition popularity values 56 are higher indicating less traffic meaning that the route 60 is more easily traversed than the same route 60, as shown in FIG. 4B on a day 45 of the week of Tuesday, a date 43 of January 15 and a time 41 of 8:15 am. In the winter near a school at a time when the students are being dropped off, there is more traffic and activity which would lower the average speed values 54 and lower the transition popularity values 56 because it is harder to transition from one geospatial and temporal segment to another. The Runkeeper™ application 10 develops the temporal factor 47 from the temporal indicator 37 and the temporal components 39 of time 41, date 43 and day 45 if available for a particular type of runnability data 40. As shown in FIG. 4A, the average speed value 54 based on all of the collected data may be determined through averaging as an example as a value of four (4). By then evaluating the temporal components 39 of each data element of collected average speed data and limiting those data elements to those that have temporal components 39 similar to the temporal indicator 37, the data can be filtered then averaged for example and the temporal factor 47 can be determined. From the reduced data set of data collected or referred to having temporal components 39 in the July or in the summer months as a criterion, the average speed value 54 is adjusted from a value of four (4) to a value of eight (8) in this example as shown in the value at 54a for the segment 28a in the runnability map 26. In a similar analysis, the transition popularity value 56 is adjusted by the temporal factor 47 from a value of five (5) to a seven (7) based on the reduced data set of temporal components 39 in the summer months as shown in this example in the value at 56a for the same segment 28a that the known route 60 goes through. As shown in FIG. 4B, with the change to the temporal indicator 37, the collected or referred data having temporal components 39 may be restricted to data from January or only from winter months as a criterion. The temporal factor 47 adjusts the average speed value 54 and decreases the value of four (4) to a value of two (2) in this example as shown in the value at 54a for the segment 28a in the runnability map 26. In a similar analysis, the temporal factor 47 adjusts the transition popularity value 56 and decreases the value of five (5) to a seven (3) based on the reduced data set of temporal components 39 in the winter months as shown in this example in the value at 56a for the same segment 28a. An analysis of the temporal components 39 using the Runkeeper™ application 10 therefore provides indicators that the same known route 60 or created route 32 may have higher rankings at certain times such as a weekend day in July than on a busy school day in January. The temporal analysis can therefore be an important indicator of change along a route during a day, a time of year, or a day of the week or a specific day and date when an event such as a parade or fundraiser is planned increasing the traffic and activity at a specific day 45 date 43 and time 41. Other examples using the temporal factor 47 for adjustment may be based on additional runnability data 40 on lighting where an area that is brightly lit with sunshine during certain times of the day but has poor lighting and may be more difficult to traverse or be unsafe in the evening. The direction of travel with temporal components 39 may also be captured as runnability data 40 where heading east in early morning or west in late evening may be blinding in certain areas on sunny days so the values of the collected runnability data may be adjusted based on the temporal indicator 37 and the entered direction of travel by a user. Some types of runnability data 40 such as the gradient values 58 and others based on geophysical structures will not have temporal components 39 because the change to these values is very infrequent, so these values will most often remain constant within the runnability map 26.

In determining the runnability value for one type of runnability data 40 where all or portions of, for example, a known route 60 are within the runnability map 26, all of the geospatial and temporal segments 28 may receive the same popularity values 52 which may be an average of all popularity values 52 collected from users of that known route 60. In other examples, all of the popularity values 52 for the route 60 are adjusted by the same temporal factor 47 based on the temporal indicator 37 and temporal components 39 of the collected popularity data. In some embodiments, each geospatial and temporal segment 28 of the known route 60 receives a popularity value 52 that is an average of the popularity value 52 divided by the total number of geospatial and temporal segments 28 within the runnability map 26 that are traversed by the known route 60 to more properly apportion the popularity value 52 and/or temporal factor 47 adjustment to the number of geospatial and temporal segments 28 that are actually within the runnability map 26. In some locations 30, as shown in FIG. 4B, there may be popularity data from more than one known route that traverses the geospatial and temporal segments 28 within the runnability map 26. In such cases, a geospatial and temporal segment that is traversed by more than one route indicated as 28b in this example that is traversed by both the first known route 60 and second known route 62, the popularity value 52 may be determined by averaging the two popularity values 52 together or by scaling a higher value down if a lower value is below a preset threshold, or by other methods. Within the runnability map 26, the popularity value 52 may be derived by scaling the popularity values from all running routes that are within the selected geospatial and temporal segments 28 in order to accurately assign higher popularity values 52 to the more popular route as compared to other routes.

As shown in FIG. 4C, the runnability value scale 48 may further be adjusted to reflect user preferences or other requirements to determine the set of criteria needed to create an optimal route 32 for the user. For example, if an entered user preference requests an easier pace over flatter terrain, the Runkeeper™ application 10 in some embodiments implements runnability value scales 48 that give higher values for lower average speeds 54 across a geospatial and temporal segment 28 and higher gradient values 58 for geospatial and temporal segments 28 with less elevation and lower gradient transitions as shown by the scale 48 and the descriptions 50. By adjusting the runnability value scale 48 to weigh particular requirements more heavily than others as dictated for example by a user, the runnability value for a particular type of runnability data 40 for each geospatial and temporal segment 28 is adjusted to those user preferences where as shown in FIG. 4C, prior low average speed values 54 become higher average speed values 54 and less steep geospatial and temporal segments 28 are given higher gradient values 58 and more steep geospatial and temporal segments 28 are given lower gradient values 58. The Runkeeper™ application 10 may therefore use the adjusted values of the runnability data 40 to develop a route 32 that meets the particular requirements of the user. A particular type of runnability data 40, may further be adjusted or weighted more heavily based on for example its location within the runnability map 26. For example, if the transition popularity 56 is from one segment 28 within the geospatial and temporal segments 28 within the runnability map 26 to one or more geospatial and temporal segments 28 also within the runnability map 26, a higher value for the greater number of transitions may be given to each of these geospatial and temporal segments 28 within the runnability map 26, than to other geospatial and temporal segments 28 with transition popularity values 56 that transition to a geospatial and temporal segment 28 outside of the runnability map 26. As shown in FIG. 4C, because the center geospatial and temporal segment 28c transitions to all segments and all segments are within the runnability map 26, the transition popularity 56b value may be scaled to be given a higher value. Other algorithms and methodologies for the determination of a value for each type of runnability data 40 for each segment 28 are within the scope of this present invention.

As a next procedural step, the values determined for each type of runnability data 40 within each geospatial and temporal segment 28 are compiled and a weighted runnability segment value 64 for each geospatial and temporal segment 28 is determined. The determination of the weighted runnability segment value 64 may be through a weighted average analysis that takes each type of runnability data 40 and assigns a contribution factor 59 of the particular type of runnability data 40 to the overall quality of the route created. This contribution factor 59 may be based on user preferences like popularity, on a geophysical attribute like gradient, or the temporal components 39 related to the temporal indicator 37 for the time 41 of day, date 43, or day 45 of the week, such as the weather or weather forecast during the time that the user will be performing the activity along the created route 32. As shown in FIG. 4C, by giving each of in tis example the four types of runnability data 40 a contribution factor 59 based on a user preference, the popularity value 52 and the less steep gradient value 58 have a larger percentage of contribution to a calculated overall weighted runnability segment value 64 for each geospatial and temporal segment 28. The geospatial and temporal segments 28 that have higher popularity values 52 and less steep gradient values 58 have higher weighted runnability segment values 64 and will therefore be preferred and ranked higher in the selection by the Runkeeper™ application 10 of segments 28 for the created routes 32. The weighted runnability segment value 64 as a weighted average of the values of the different types of runnability data 40 associated with each geospatial and temporal segment 28 may preferably be the only valued displayed on the runnability map 26 to more effectively communicate the segments 28 chosen for one or more created routes, as shown in FIG. 4D. In some embodiments, the runnability map 26 may be shaded or color coded for a user to identify patterns of higher or lower weighted runnability segment values 64, as shown in FIG. 4E.

In a route creation analysis, only some of the types of runnability data 40 within each geospatial and temporal segment 28 may be used. The selection of these types and the amount of the contribution factor 59 can be based on user preferences, terrain within a certain location 30, the amount of available runnability data, scaling and averaging of data from different sources, the temporal components 39 of the time 41 of day, date 43, or day 45 of the week, as well as on other factors and requirements of the user and of the environment. The runnability segment value 64 for each particular geospatial and temporal segment 28 may further be changed to a different value based on changes in criteria, the time of day, environmental conditions, such as weather, the source or sources of the data and on other factors to provide the most accurate and timely information for each geospatial and temporal segment 28 in developing one or more optimal routes 32 for a user. For example, weather may have a larger contribution factor 59 if there is excessive wind within certain geospatial and temporal segments 28 within the runnability map 26. The geospatial and temporal segments 28 that have strong winds such as along a body of water may be given lower weather runnability values than geospatial and temporal segments within a forest so that a preference and higher rating for creating routes within a more protected area is given.

The process of determining a weighted runnability segment value 64 for each geospatial and temporal segment 28 incorporates runnability data 40 from the GIS Server 14 which provides environmental conditions and information for each geospatial and temporal segment 28 and from the User Preference Server 16 that provides activity, preferences, and comments as well as other information. An embodiment of the steps for associating a weighted runnability segment value 64 with each geospatial and temporal segment 28 is shown in FIG. 4F. In step 200, the user enters or selects the temporal indicator 37 that provides the date and time when they will be performing their activity along the created route 32 and the user enters or selects their desired user preferences. In step 202, one or more different types of available runnability data 40 is accessed from the GIS Server 14 and User Preference Server 16 and each type of runnability data 40 may include temporal components 39 related to the time and date when the runnability data 40 was collected or to a time and date that the runnability data 40 refers to. In some types of runnability data 40, this may be a future time and date such as in runnability data 40 for a weather forecast. In step 204, each available type of runnability data 40 is associated with each geospatial and temporal segment 28. In step 206, adjustments to the values of each type of runnability data 40 are made based on the user preferences and temporal indicator 37. If no user preferences are entered, then a temporal factor 47 may still be applied to adjust the runnability data 40 based on the temporal indicator 37 entered or selected. Default values for user preferences based on the collected runnability data 40 may be used and the default values may be adjusted based on an analysis of prior user preferences. In step 208, a contribution factor is determined based on user preferences, environmental conditions, predefined thresholds of runnability data or other factors and the weighted average from each type of runnability data 40 in each geospatial and temporal segment 28 is compiled to determine a weighted runnability segment value 64 that is calculated for each geospatial and temporal segment 28. In step 210 the calculated weighted runnability segment value 64 is associated with that particular geospatial and temporal segment 28. In step 212, the weighted runnability segment value 64 for each geospatial and temporal segment 28 is displayed on the runnability map 26. In further steps the runnability map 26 may be shaded or color coded based on the weighted runnability segment value 64. Other types of analysis based on previously collected runnability data, averaging, statistical variance, or using other algorithms and methodologies may be used to determine the weighted runnability segment value 64 of each geospatial and temporal segment 28.

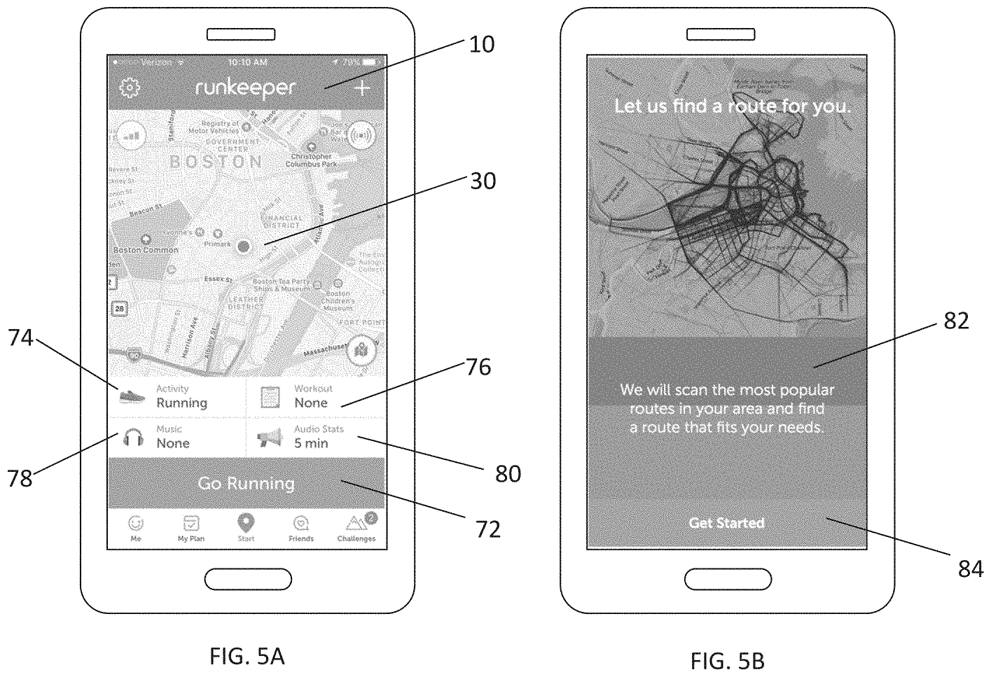

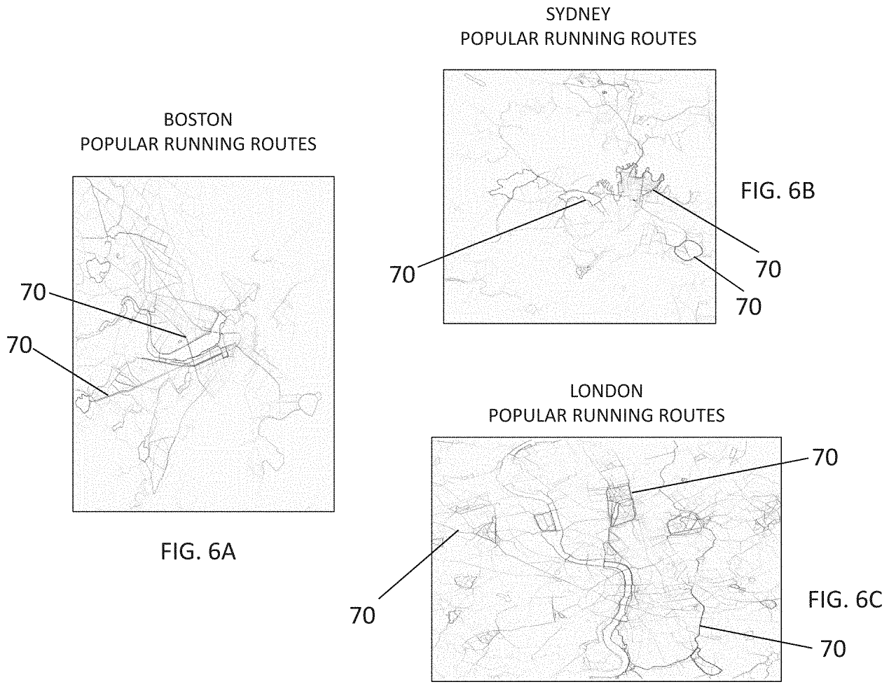

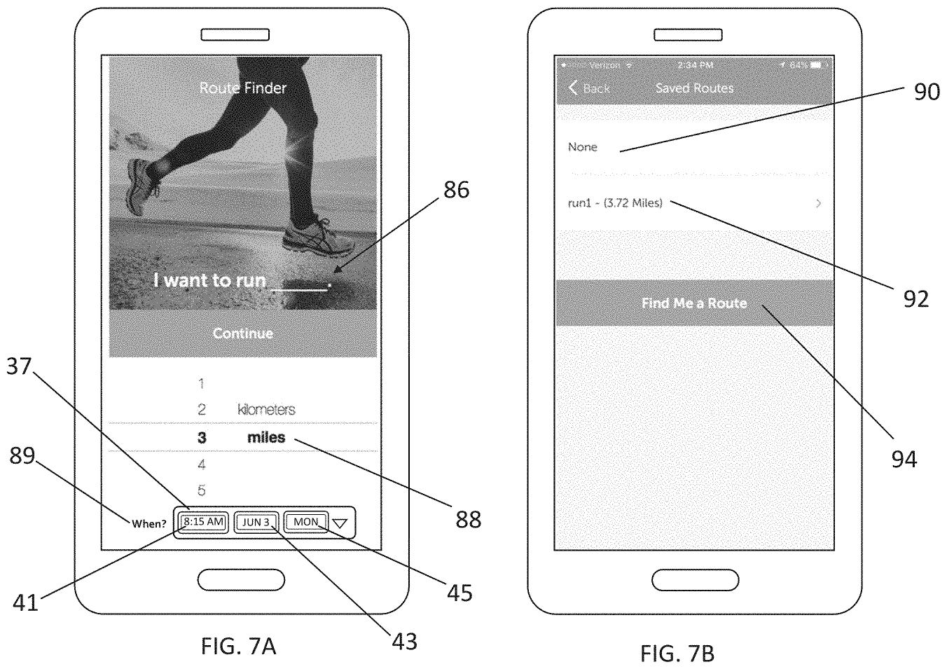

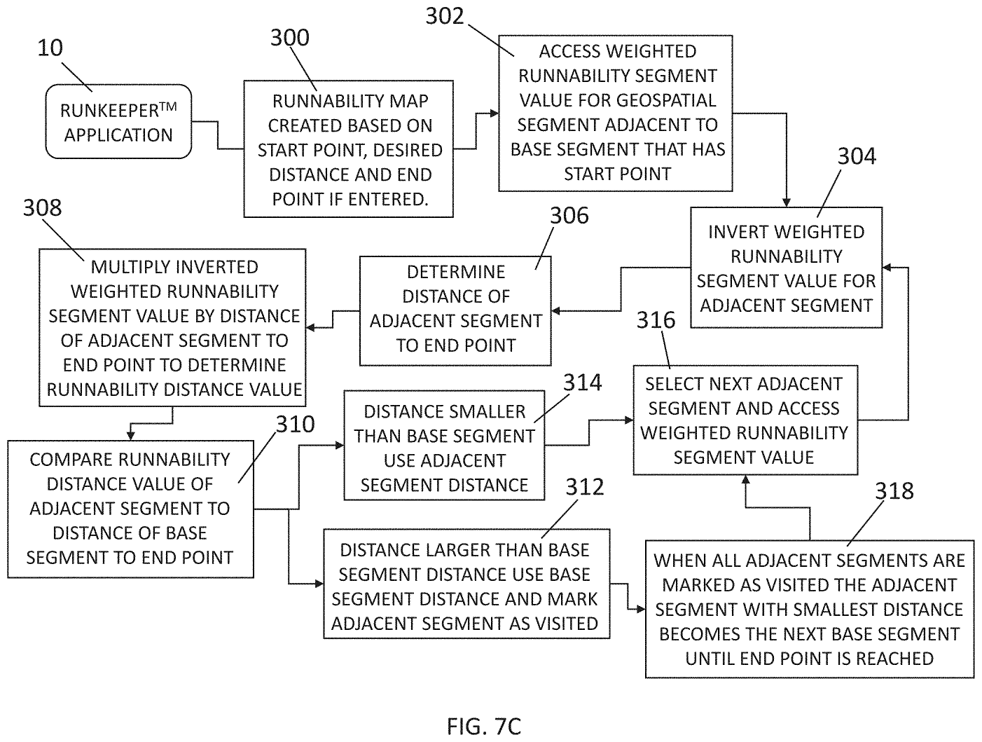

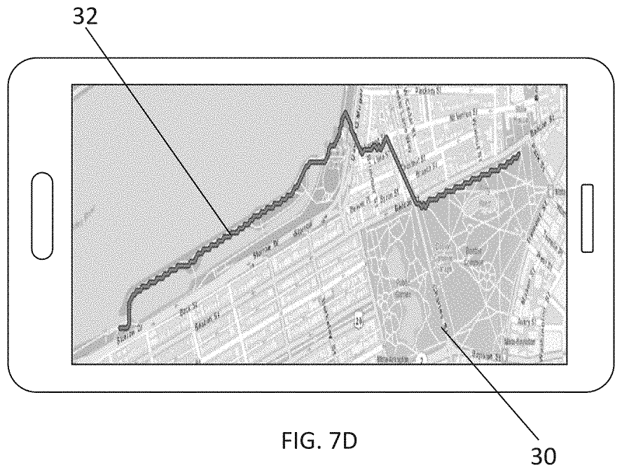

In an embodiment of the Runkeeper™ application 10 access to the application is provided using a “Go Running” access bar 72, shown in FIG. 5A. Options to other features are accessible through menu items, such as access to an Activity 74, a Workout Calendar 76, Music 78, and Statistics 80. The location 30 of the user or a location selected by the user may also be displayed. By selecting the Go Running access bar 72, the Runkeeper™ application 10 opens an introductory screen 82 that scans for the most popular routes within the location 30. An example of a type of runnability data 40 for popular routes 70 in different cities is shown FIGS. 6A-6C. Information on these popular routes 70 for each city is stored within the User Preference Server 16 with popularity data 52 for each route to be accessed by the Runkeeper™ application 10. Once scanned a “Get Started” access bar 84 prompts the user for further information. A distance prompt 86 prompts the user for the distance that they want to run, as shown in FIG. 7A. A units option 88 provides for the user to select the units in kilometers or miles for the distance they want to run. An endpoint may optionally be entered. A “When” prompt 89 is displayed with the current time 41, date, 43 and date 45 with the option to adjust to plan when the user will run the route to have the user enter the temporal indicator 37. Additional user preferences may be entered or selected, but if none are selected a User Preference Prompt 90 of “none” may be displayed as shown in FIG. 7B. A Miles Prompt 92 shows the entered miles and a “Find Me a Route” Prompt 94 begins the creation of one or more routes by the Runkeeper™ application 10. The shortest distance through the geospatial and temporal segments 28 is determined using for example the modification to the Dijkstra's algorithm that inverts the weighted runnability segment value 64 of a geospatial and temporal segment 28 as shown in the steps for creating one or more routes 32 in FIG. 7C. In step 300, the runnability map 26 is created for the location based on the start point 34 and desired distance and an end point 36 if one has been entered. In step 302, the weighted runnability segment value 64 is accessed for a segment that is adjacent to the base segment that has the start point 34. The weighted runnability segment value 64 is inverted at step 304. The distance of the adjacent segment to the end point 36 is determined at step 306. As noted above if an end point 36 has been entered then this location is used to determine distance. If an end point 36 has not been entered, then the route creation analysis is repeated for a number of end points that have the same desired distance. The inverted runnability value is multiplied by the distance to determine the runnability distance value at step 308. At step 310, the runnability distance value is compared to the distance of the base segment that has the start point 34 to the end point 36. If the runnability distance value is larger than the distance of the base segment to the end point, the adjacent segment is marked as visited in step 312. If the runnability distance value is shorter than the distance of the base segment to the end point, the adjacent segment is used as the distance in step 314. A next segment adjacent to the base segment is selected and the weighted runnability segment value 64 of that adjacent segment is accessed at step 316. The process repeats with the inversion of the weighted runnability segment value 64 and multiplying of the value by the distance which is then compared and if shorter than the next adjacent segment is selected as the base segment until all geospatial and temporal segments 28 within the runnability map 26 are marked as visited and/or the end point is reached in step 318. The geospatial and temporal segments 28 selected as base segments create a route having higher weighted runnability segment values 64 and a distance shorter than other geospatial and temporal segments 28 that do not have as high weighted runnability segment values 64. As shown in FIG. 7D, the Runkeeper™ application 10 rates the created routes based on the runnability distance values and displays one or more optimal route 32. In some embodiments, based on the temporal indicator and user preferences or other geophysical information, a single type of runnability data 40 such as the popularity value 52 of the geospatial and temporal segments 28 may be inverted and multiplied by the distance for the creation of a route to identify routes having the highest values of this type of runnability data 40. The popularity value 52 in each geospatial and temporal segment 28 may be adjusted based on the temporal indicator 37 and temporal components 39 of the popularity data collected. Using these popularity values 52 adjusted by the temporal factor 47, routes 32 that are optimal for the temporal indicator 37 and that have the most popular geospatial and temporal segments 28 within the runnability map 26 are created.

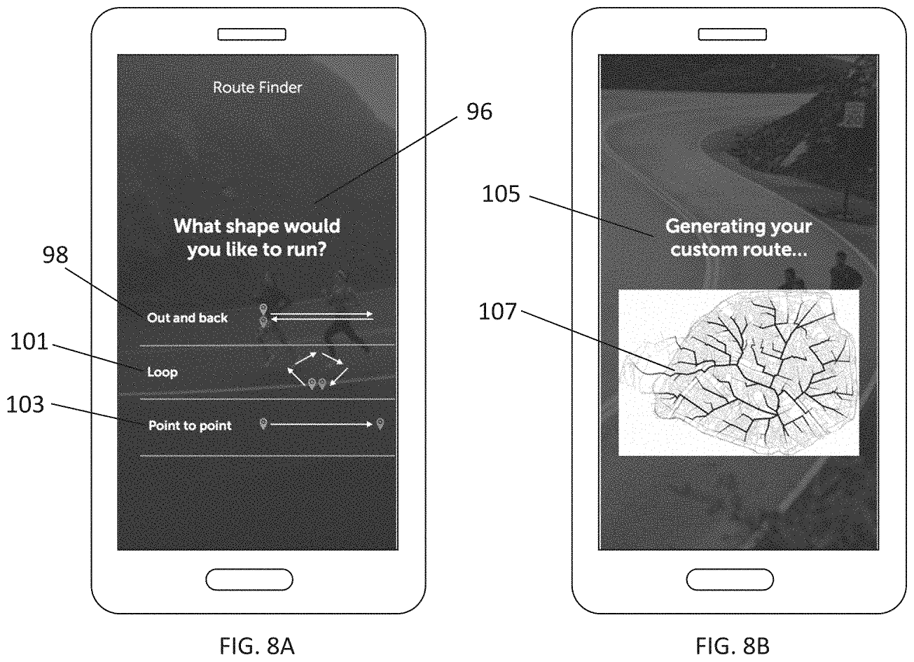

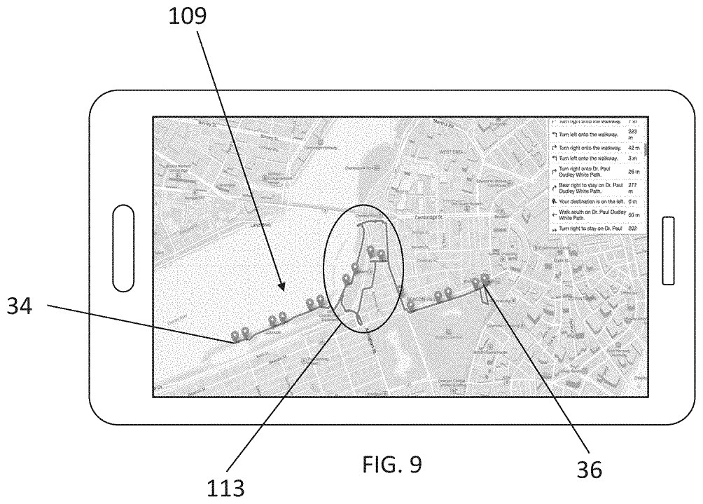

In some embodiments, the user may select special preferences as noted above, and/or optionally select for the route 32 to follow a particular type of path, such as out and back, add in a loop, back-track and/or overlap and traverse point to point within the geospatial and temporal segments 28, as shown in FIG. 8A. The Runkeeper™ application 10 provides a “What shape would you like to run?” Prompt 96 and options to select a shape or path as Out and Back 98 which provides for overlapping of the entire route, a Loop 101 that provides for overlapping a portion of the route, and a Point to Point 103 that has a start point 34 and end point 36 with no overlapping of the route. Once a shape or path is selected, the Runkeeper™ application 10 begins and displays a dialog box 105 that communicates that a route is being created based on the selected shape or path criteria, as shown in FIG. 8B. The display may further provide a route creation graphic 107 that updates as optional routes linking the geospatial and temporal segments 28 are evaluated by the Runkeeper™ application 10. As the evaluation continues, routes connect geospatial and temporal segments 28 and then overlap some or all of these geospatial and temporal segments 28 to form the desired shape that meets the desired distance and desired user preferences if any have been entered. The Runkeeper™ application 10 creates a number of routes that meet the user criteria and then these routes are ranked at higher or lower values than previously analyzed routes until the optimal route 32 is determined. For example, a user preference may enter or select an option for scenery along the route, which creates a scenic route 109 that as shown in FIG. 9 begins from a start point 34 and extends along a river and then a loop 113 directs the scenic route 109 through streets and then a portion of the scenic route 109 overlaps to extend again along the river and then extend to an end point 36 with the distance and difficulty based on the desired distance and user preferences.

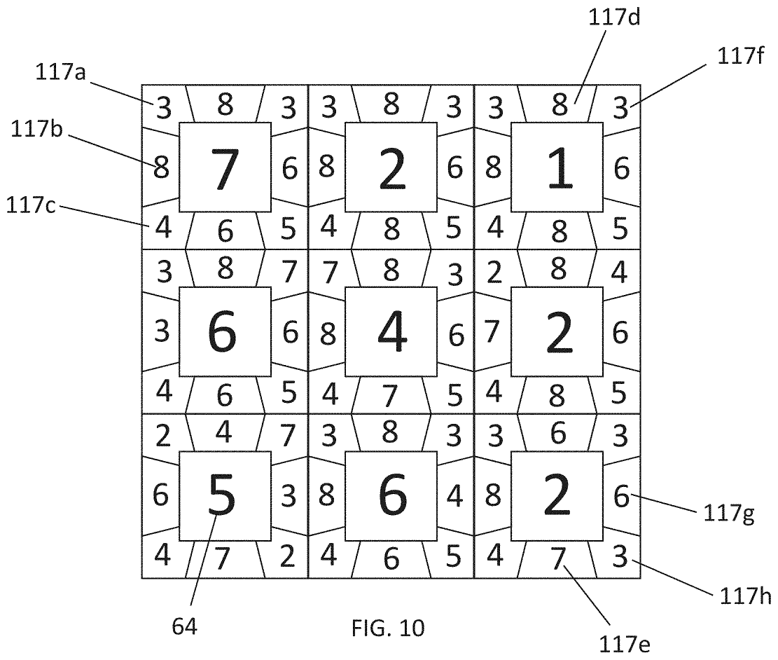

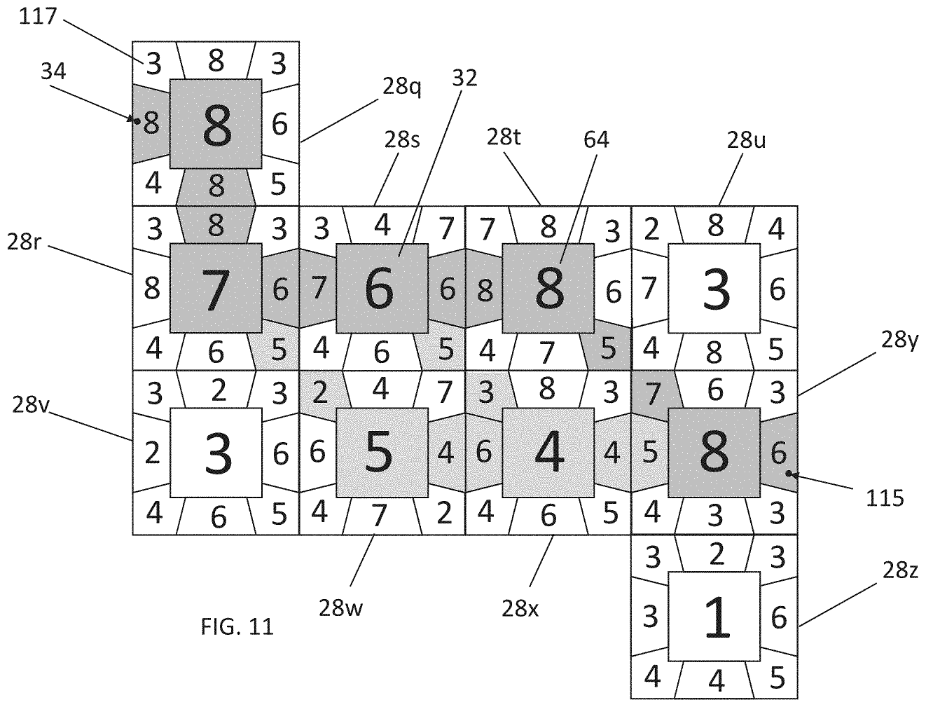

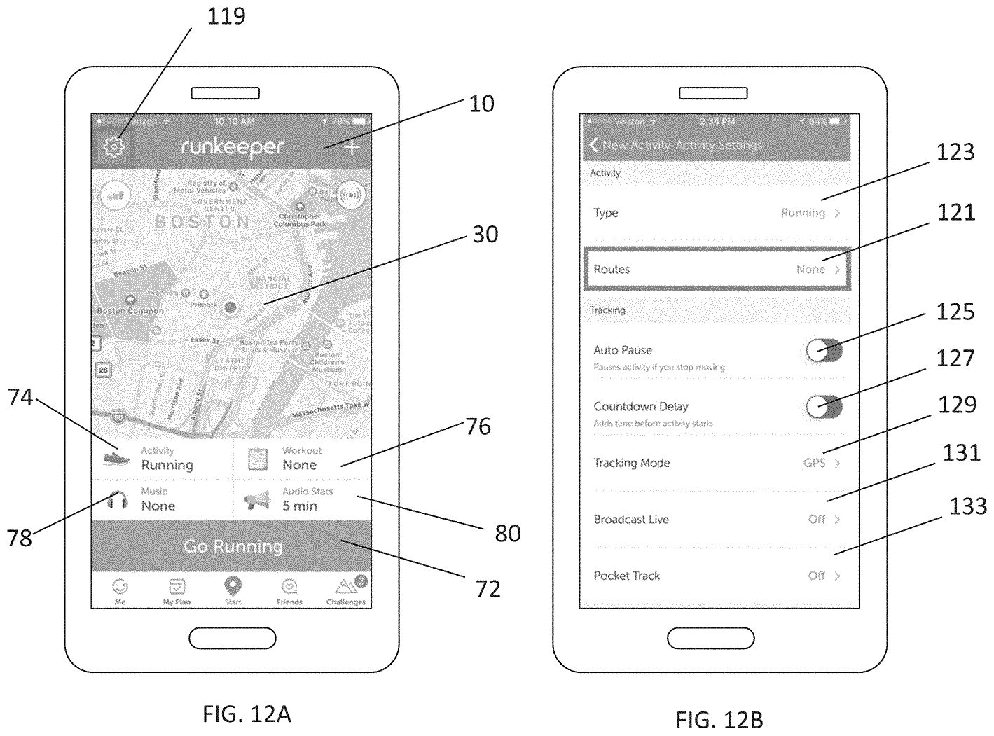

The Runkeeper™ application 10 uniquely provides the ability to create overlapping paths such as out and back and loops within the route 32 because of the creation of the route 32 using geospatial and temporal segments 28 so that the route 32 may alter its direction at any transition point where one geospatial and temporal segment 28 meets another. As shown in FIG. 10, the transition points between the geospatial and temporal segments 28 are in all eight directions from a center or other point within a geospatial and temporal segment 28 through each of the four sides 117b, 117d, 117e, and 117g and through the four corners 117a, 117c, 117f, and 117h of the geospatial and temporal segment 28. The edge values 117a-117h of each geospatial and temporal segment 28 may represent the transition popularity 56 in each direction from each geospatial and temporal segment 28 to each adjacent geospatial and temporal segment 28. As the available routes are being determined, the weighted runnability segment values 64 and edge values 117a-117h are combined, averaged, scaled, or otherwise integrated to develop weighted digraphs to indicate preferential directions through the geospatial and temporal segments 28 of the runnability map 26 and from these preferential directions determine an optimal route 32 for the user. As noted above, using Dijkstra's algorithm and by inverting the weighted runnability segment value 64 a preferred distance can be determined. By then evaluating the edge values 117a-117h of each segment a preferred direction can be determined. As shown in FIG. 11, the weighted runnability segment value 64 of a geospatial and temporal segment 28r adjacent to a base geospatial and temporal segment 28q that includes the start point 34 is inverted and multiplied by the distance from the adjacent segment 28r to the end point. This runnability distance value is compared to the distance from the base geospatial and temporal segment 28q to the end point 36 and if it is less, the adjacent geospatial and temporal segment 28r is marked as visited and this runnability distance value is kept as the tentative distance. A comparison of the distance of the base geospatial and temporal segment 28q with the runnability distance value of the next adjacent geospatial and temporal segment 28s is made and if the new distance to the end point 36 is less than the tentative distance, the new runnability distance value becomes the tentative distance and the next geospatial and temporal segment 28s is marked as visited. All of the geospatial and temporal segments (28r and 28s in this example) adjacent to the base geospatial and temporal segment 28q are used in the Dijkstra's algorithm analysis with the weighted runnability segment value 64 inversion. The base geospatial and temporal segment 28q is marked as visited and the geospatial and temporal segment 28s associated with the tentative distance becomes the new base geospatial and temporal segment and the analysis continues until all geospatial and temporal segments 28q are marked as visited or the end point 36 is reached. The geospatial and temporal segments 28 having a tentative distance and marked as new base segments are identified and used in a weighted digraph analysis that selects the direction based on the weighted runnability segment values 64 and the edge values 117a-117h of each geospatial and temporal segment 28 to determine an optimal route 32. Geospatial and temporal segments 28 having lower weighted runnability segment values 64 and edge values 117a-117h based on user preferences and other geophysical and environmental factors have a lower probability of being included in the optimal route 32. As shown in this example in FIG. 11, the lighter shaded segments through geospatial and temporal segments 28w and 28x provide a similar distance to the end point 36 but have lower weighted runnability segment values 64 and the edge values 117 than the darker shaded geospatial and temporal segments 28 through geospatial and temporal segments 28s and 28t meaning that even if the distance is similar, the Runkeeper™ application 10 evaluation penalizes geospatial and temporal segments 28 of lower weighted runnability segment values 64 and edge values 117 and selects the geospatial and temporal segments 28 having higher weighted runnability segment values 64 and edge values 117 to best optimize a route 32 for the user. By dissecting a location into geospatial and temporal segments 28 the Runkeeper™ application 10 uniquely provides for routes to be constructed through connecting the geospatial and temporal segments 28 having the most optimal geophysical, temporal, and user preference features to best determine an optimal route 32 for a user. As shown in FIG. 12A, the Runkeeper™ application 10 provides for Settings 119 to be selected for a user to access Routes 121 as shown in FIG. 12B. The Settings 119 further provide for a selecting an Activity 123 as for example running, walking or cycling. Further Settings 119 may include tracking of the user with an Auto Pause 125 option to turn the tracking off when the user has stopped, a Countdown Delay 127 that sets a timer to or an alarm at the time when the activity will begin, and an option of setting the type of Tracking Mode 129 using GPS and/or for example an RFID Tag 20 that is worn on the running shoe or otherwise attached to the user. Options to Broadcast 131 the user's location through for example social media or track portions of the activity through a Pocket Track 133 application are other optional features.

Although specific embodiments of the invention have been disclosed herein in detail, it is to be understood that this is for purposes of illustration. This disclosure is not to be construed as limiting the scope of the invention, since the described embodiments may be changed in detail as will become apparent to those skilled in the art in order to adapt the invention to particular applications, without departing from the scope of the following claims and equivalents of the claimed elements.

What is claimed is:

1. A system for the creation of one or more routes, comprising:
a processor;
a non-transitory computer readable medium within a network of central processing units having memory and data storage and having embodied thereon one or more computer programs causing one or more of the central processing units to store instructions that when executed, cause the system to perform;
accessing a start point and desired distance;
generating a runnability map comprising a plurality of geospatial and temporal segments derived from latitude and longitude of the start point and desired distance;
associating runnability data with each geospatial and temporal segment, the runnability data of a geospatial and temporal segment having a value representing the runnability conditions of that geospatial and temporal segment;
selecting adjacent geospatial and temporal segments having greater runnability segment values that extend from the start point to an end point at the desired distance from the start point;
connecting the adjacent geospatial and temporal segments having the greater runnability segment values to configure the display a plurality of created routes from the start point to the desired distance.

2. The system of claim 1, comprising:
accessing user preference runnability data;
storing user preference runnability data;
limiting the access of the runnability data within the geospatial and temporal segments of the runnability map to the user preference runnability data;
creating routes based on the runnability data constrained by the user preference runnability data.

3. The system of claim 2, comprising:
creating the plurality of routes based on stored user preference runnability data.

4. The system of claim 2, comprising:
rating the plurality of created routes based on user preference runnability data.

5. The system of claim 1, comprising:
rating the plurality of created routes based on the runnability segment values of the adjacent geospatial and temporal segments within the created route.

6. The system of claim 1, comprising:
accessing a temporal indicator that includes the time entered or selected by a user of when the user will perform an activity along one of the plurality of created routes;
accessing a type of runnability data associated with the geospatial and temporal segments within the runnability map;
determining a runnability value from the associated type of runnability data using one or more of averaging, scaling, weighing or other methodologies;
accessing temporal components related to the type of runnability data;
correlating the temporal components of the type of runnability data to the temporal indicator;
removing from the analysis of the determination of a runnability value any data elements that do not have temporal components that correlate to the temporal indicator;
determining a runnability value from the remaining data elements of the type of runnability data; and
adjusting the runnability value by a temporal factor derived from the correlation of the temporal components of the runnability data to the temporal indicator.

7. The system of claim 6, comprising:
accessing types of runnability data of at least one of direction of travel, the average speed of travel, the popularity of the segment, the popularity of traversing from one segment to an adjacent segment, variations in traffic and lighting during specific times of day, current weather conditions and weather forecasts, and the quality of the GPS signal within each segment. The system of claim 1, comprising:
accessing types of runnability data comprising edge values representing a comparison of a runnability segment value of one geospatial and temporal segment with the runnability segment value of an adjacent geospatial and temporal segment, with each geospatial and temporal segment having up to eight edge values.

8. The system of claim 7, comprising:
determining a contribution factor for each type of runnability data;
determining a weighted runnability segment value for each geospatial and temporal segment from a determined runnability value for each type of runnability data and the contribution factor for that type of runnability data.

9. The system of claim 1, comprising:
determining the direction of the plurality of created routes based on the edge values of two adjacent geospatial and temporal segments.

10. The system of claim 1, comprising:
dividing the desired distance in half;
creating routes that start and end at the same location by overlapping the created route from the start point to a point that is one-half of the desired distance; and
returning to the start point.

11. The system of claim 1, comprising:
creating loops within a route by identifying adjacent geospatial and temporal segments suitable to traverse and return to non-adjacent geospatial and temporal segments, the loop comprising a distance that is a portion of the desired distance.

12. The system of claim 1, comprising:
accessing runnability data comprising geophysical data including elevation, altitude, topology, transportation routes, location pictures, and geocoding to identify natural geophysical features of the environment such as rivers and lakes, man-made structures such as buildings, roads and bridges, weather, and address information within the user location;
identifying geospatial and temporal segments having non-traversable geophysical features within the runnability map.

13. The system of claim 1, comprising:
determining a tentative distance from the distance from the start point to an end point;
selecting a geospatial and temporal segment adjacent to the geospatial and temporal segment comprising the start point;
determining the distance from the adjacent geospatial and temporal segment to the end point;
accessing a weighted runnability segment value from the adjacent geospatial and temporal segment;
inverting the weighted runnability segment value;
determining a runnability distance value as the product of the distance of the adjacent geospatial and temporal segment to the end point and the inverted weighted runnability segment value;
marking the adjacent geospatial and temporal segment as visited.

14. The system of claim 1, comprising:
determining a tentative distance from the distance from the start point to an end point;
selecting a geospatial and temporal segment adjacent to the geospatial and temporal segment comprising the start point;
determining the distance from the adjacent geospatial and temporal segment to the end point;
accessing a runnability value from one type of runnability data from the adjacent geospatial and temporal segment;
inverting the runnability value from the one type of runnability data;
determining a runnability distance value as the product of the distance of the adjacent geospatial and temporal segment to the end point and the inverted runnability value from the one type of runnability data;
marking the adjacent geospatial and temporal segment as visited.

15. The system of claim 13, comprising:
comparing the distance of the start point to the end point with the runnability distance value of the adjacent segment;
identifying the shorter distance as the tentative distance;
selecting a next geospatial and temporal segment adjacent to the geospatial comprising the start point;
determining the distance from the next adjacent geospatial and temporal segment to the end point;
accessing a weighted runnability segment value from the next adjacent geospatial and temporal segment;
inverting the weighted runnability segment value of the next adjacent geospatial and temporal segment;
determining a runnability distance value as the product of the distance of the next adjacent geospatial and temporal segment to the end point and the inverted weighted runnability segment value;
comparing the tentative distance to the runnability distance value;
identifying the shorter distance as the tentative distance;
marking the next geospatial and temporal segment as visited.

16. The system of claim 13, comprising:
determining a runnability distance value for all geospatial and temporal segments adjacent to the geospatial and temporal segment having the start point;
comparing the distance of the start point to the end point with the runnability distance value of all geospatial and temporal segments adjacent to the geospatial and temporal segment having the start point;
identifying the shortest distance as the tentative distance;
selecting the geospatial and temporal segment associated with the tentative distance as the base segment;
marking all geospatial and temporal segments in the comparison as visited;
determining a runnability distance value for all geospatial and temporal segments adjacent to the base segment;
comparing the distance of the base segment to the end point with the runnability distance value of all geospatial and temporal segments adjacent to the base segment;
identifying the shortest distance as the tentative distance;
selecting the geospatial and temporal segment associated with the tentative distance as the base segment;
marking all geospatial and temporal segments in the comparison as visited;
repeating the determination of the runnability distance value for all geospatial and temporal segments adjacent to the base segment; and
repeating the comparison and identification of the tentative distance until the end point is within a geospatial and temporal segment marked as visited;
creating a route of adjacent geospatial and temporal segments identified as base segments.

17. The system of claim 1, comprising:
communicating directions along the created route using a headset.

18. The system of claim 1, comprising:
determining the location of a user along a created route using an RFID Tag.
